(19) United States
(12) Patent Application Publication
(10) Pub. No.: US 2026/0127050 A1
(43) Pub. Date: May 7, 2026

(54) HARDWARE COUNTERS

(71) Applicant: Arm Limited, Cambridge (GB)

(72) Inventor: Mark UNDERWOOD, Cambridge (GB)

(21) Appl. No.: 18/939,739

(22) Filed: Nov. 7, 2024

(51) Int. Cl. G06F 9/54

(52) U.S. Cl. CPC G06F 9/542

(57) ABSTRACT

An apparatus comprises a plurality of hardware counters each corresponding to a separate sub-range of a contiguous range of target values, and histogram control circuitry to perform an indexing operation to identify and increment a selected hardware counter corresponding to a selected sub-range comprising an input value. Responsive to a histogram range update trigger, adding circuitry adds a count value of one or more first hardware counters corresponding to one or more first sub-ranges to a second hardware counter corresponding to a second sub-range neighbouring the one or more first sub-ranges, and the histogram control circuitry updates a previous indexing operation to an updated indexing operation, wherein the updated indexing operation identifies one of the one or more first hardware counters in response to an input value lying within a newly defined sub-range of the contiguous range of target values.

### BACKGROUND

### Technical Field

The present technique relates to the field of data processing. In particular, it relates to the use of hardware counters for providing a histogram.

### Technical Background

Histograms can provide information regarding the distribution of values of an input. Histograms may be implemented in the hardware of a data processing apparatus for monitoring various values within the processing apparatus.

### SUMMARY

At least some examples of the present technique provide an apparatus, comprising:
a plurality of hardware counters each corresponding to a separate sub-range of a contiguous range of target values; and
histogram control circuitry responsive to an input value to perform an indexing operation to identify and increment a selected hardware counter corresponding to a selected sub-range comprising the input value;
wherein, responsive to a histogram range update trigger:
   adding circuitry is configured to add a count value of one or more first hardware counters corresponding to one or more first sub-ranges to a second hardware counter corresponding to a second sub-range neighbouring the one or more first sub-ranges; and
   the histogram control circuitry is configured to perform an indexing operation update to update a previous indexing operation to an updated indexing operation, wherein the updated indexing operation identifies one of the one or more first hardware counters in response to an input value lying within a newly defined sub-range of the contiguous range of target values.

At least some examples provide a method, comprising:
providing a plurality of hardware counters each corresponding to a separate sub-range of a contiguous range of target values;
responsive to an input value, performing an indexing operation to identify and increment a selected hardware counter corresponding to a selected sub-range comprising the input value; and
responsive to a histogram range update trigger:
   adding a count value of one or more first hardware counters corresponding to one or more first sub-ranges to a second hardware counter corresponding to a second sub-range neighbouring the one or more first sub-ranges; and
performing an indexing operation update to update a previous indexing operation to an updated indexing operation, wherein the updated indexing operation identifies one of the one or more first hardware counters in response to an input value lying within a newly defined sub-range of the contiguous range of target values.

At least some examples provide a non-transitory computer-readable medium storing computer-readable code for fabrication of an apparatus, comprising:
a plurality of hardware counters each corresponding to a separate sub-range of a contiguous range of target values; and
histogram control circuitry responsive to an input value to perform an indexing operation to identify and increment a selected hardware counter corresponding to a selected sub-range comprising the input value;
wherein responsive to a histogram range update trigger:
   adding circuitry is configured to add a count value of one or more first hardware counters corresponding to one or more first sub-ranges to a second hardware counter corresponding to a second sub-range neighbouring the one or more first sub-ranges; and
the histogram control circuitry is configured to perform an indexing operation update to update a previous indexing operation to an updated indexing operation, wherein the updated indexing operation identifies one of the one or more first hardware counters in response to an input value lying within a newly defined sub-range of the contiguous range of target values.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates circuitry for providing a histogram in hardware.

FIG. 2 schematically illustrates an example of adding circuitry.

FIG. 3 schematically illustrates three examples of sub-ranges corresponding to a set of four hardware counters labelled #0 to #3.

FIG. 4 is a table providing several example input values and the identified hardware counters for those input values when the base index is 1.

FIG. 5 schematically illustrates an example implementation of a histogram.

FIG. 6 is a flow diagram illustrating a method of updating sub-ranges corresponding to a plurality of hardware counters.

FIG. 7 illustrates a system and a chip-containing product.

### DESCRIPTION OF EXAMPLES

An apparatus comprises a plurality of counters implemented in hardware. Each counter is configured to store a count value indicating a number of times a particular event has occurred. Each hardware counter corresponds to a separate sub-range of a contiguous range of target values, such that each target value in the contiguous range of target values corresponds to one of the hardware counters. The contiguous range may be finite with defined end points, or one or both ends of the contiguous range may be undefined (e.g., such that any value below a certain lower threshold or above a certain upper threshold corresponds to lowest or highest counter respectively). The apparatus also comprises histogram control circuitry responsive to an input value to perform an indexing operation to identify and increment a selected hardware counter corresponding to a selected sub-range of the contiguous range of target values, the selected sub-range comprising the input value.

Hence, the plurality of hardware counters provide a histogram recording the distribution of input values, each hardware counter storing a count value indicating a number of times an input value has been received with a value in the sub-range corresponding to that hardware counter. The sub-range of target values corresponding to each hardware counter may also be referred to as a bin of the histogram.

A hardware histogram may find various applications for tracking distributions of values in a data processing system. In general, where some aspect of a data processing system may be quantified by a value, a histogram may be provided to track the distribution of those values for various purposes such as debugging and online optimization. For instance, a histogram may be provided to track a distribution of cache access latencies (i.e., the time between a cache receiving and servicing an access request) for monitoring cache performance, a histogram may be provided for tracking a distribution of ages of evicted cache lines to use for selecting a cache replacement policy, and so on.

A histogram may be more useful when the input values are distributed relatively evenly throughout the bins. If the input values all fall within or are skewed towards a particular bin or small number of bins, then it is more difficult to determine the distribution of input values compared to the case when the values fall into separate bins (as the distribution of values within a given bin cannot be determined). In some alternative examples the sub-ranges corresponding to each hardware counter may be fixed for the lifetime of the system. This assumes that the ideal sub-ranges can be known when the system is configured and requires that these do not change. However, it can be difficult to know what the distribution of that value will be, and hence it can be difficult to define the sub-ranges for each bin in advance.

One option for selecting the sub-ranges corresponding to each hardware counter could be to define an initial setting for the sub-range boundaries, perform a trial run in which the distribution of the input value is tracked for a trial period, and then use the results of the trial run to select the sub-ranges for the histogram. For example if the trial run finds that the values are skewed towards the highest value bin when using the initial setting, an updated setting may shift the boundaries between sub-ranges to increase the number of bins at the higher end of the range. The inventor has however realised that this approach is associated with several disadvantages. First, the data obtained during the trial run is wasted. The initial settings used in the trial run may often be incorrect and hence be unable to provide useful a distinction between values observed during the trial run (e.g., if a large portion of the values fall into one bin during the trial run), and hence these values may provide limited useful data. This applies regardless of whether the bins according to the initial setting are skewed too low (in which case a large portion of the values may be counted with the highest bin), too high (in which case a large portion of the values may be counted with the lowest bin), or are in the correct portion of the range but are too large for the distribution of values (in which case many values may fall into one bin in the middle of the range). Second, the distribution of input values may change over time and hence an appropriate selection of sub-ranges for the plurality of hardware counters based on the trial run may not be appropriate at a later time.

According to the present techniques, the apparatus comprises adding circuitry responsive to a histogram range update trigger to add a count value of one or more first hardware counters corresponding to one or more first sub-ranges to a count value of a second hardware counter corresponding to a second sub-range neighbouring the one or more first sub-ranges. As discussed below, the histogram range update trigger may take various forms but may generally indicate when the histogram bins are not suitable for an observed distribution of input values and hence where the sub-ranges corresponding to each hardware counter may need to be updated. By adding the contents of one or more hardware counters to another hardware counter, the present technique allows two or more bins to be combined, hence freeing up one or more of a fixed number of hardware counters to represent a different part of the range. Combining bins enables the definition of the sub-ranges to be updated on the fly without discarding input values. In one example, the sub-ranges could initially be defined narrowly, allowing input values to be distinguished if the input values happen to be close together, and the adding circuitry allows the range to be dynamically updated by combining bins if it is instead found that the input values are more spread out or are skewed towards part of the range which would be better distinguished if the sub-ranges were updated.

A naïve implementation of the adding circuitry may involve shifting the contents of bins when defining a new sub-range. For example, when using a naïve approach to provide a new hardware counter corresponding to the top of the contiguous range, the lowest value bins could be combined and the contents of the remaining bins shifted down to the now available hardware counter so that a new highest bin corresponding to a new sub-range can be provided by the hardware counter which previously provided the highest value bin. This approach may be taken for instance to maintain an ordering of bins to simplify selecting which bin to update for a given input value. For example, if the bins are each associated with an index value then this approach would allow the index values to be left unchanged so that an input value falling in the n^{th} bin is used to update the n^{th} hardware counter before and after the range update.

However, the present inventor has realised that when implementing a histogram in hardware, this naïve approach would be associated with a significant power cost. In particular, after two bins are combined leaving one empty bin, the naïve approach would require counter shifting circuitry to perform a series of additions to shift the contents of the neighbouring hardware counter into the empty bin, and so on until the empty bin is in the location of the new sub-range. According to the present technique, the histogram control circuitry is responsive to the histogram range update trigger to perform an indexing operation update to update a previous indexing operation to an updated indexing operation, wherein the updated indexing operation identifies one of the one or more first hardware counters in response to an input value lying within a newly defined sub-range of the contiguous range of target values. Hence, rather than moving the contents of the hardware counters so that the one or more available hardware counters are in the correct location for the previous indexing operation, the present approach updates the indexing operation so that the one or more first hardware counters can be used to provide the newly defined sub-range, regardless of how the newly defined sub-range lies with respect to the sub-ranges of the other hardware counters. This can be associated with a significant power saving as there is no requirement to move the values of hardware counters which are not being combined, and hence the number of logic operations can be significantly reduced.

Therefore, according to the present techniques, a histogram may be provided with a fixed number of physical hardware counters, whilst supporting a larger number of logical bins than the physical number of hardware counters due to the possibility to perform an indexing operation to update the sub-ranges corresponding to the hardware counters. Therefore, as the sub-ranges of the hardware counters may be dynamically updated, the histogram may record input values over a larger contiguous range of target values than an initial contiguous range of target values corresponding to an initial configuration of the hardware counters.

In some examples, the histogram control circuitry may be configured to perform the indexing operation update such that the updated indexing operation and the previous indexing operation identify the same hardware counter in response to an input value lying in a range other than the one or more first sub-ranges and one or more newly defined sub-ranges. Hence, for any input value which does not correspond to a hardware counter which was combined by the adding circuitry the same hardware counter is updated before and after the histogram range update trigger, meaning that as discussed above the values of those counters do not need to be moved in response to the update, resulting in significant power savings.

Hence, in some examples, the plurality of hardware counters other than the one or more first hardware counters and the second hardware counter are configured to remain unchanged in response to the histogram range update trigger.

The selection of which one or more hardware counters are combined in response to the histogram range update trigger is not particularly limited, and may depend on the distribution of count values in the hardware counters when the histogram range update trigger is issued. However, in some examples, the one or more first hardware counters to be combined with the second hardware counter may correspond to a lowest value portion of the contiguous range of target values. Similarly, the newly defined sub-range may represent a highest value portion of the contiguous range of target values. Hence, in response to the histogram range update trigger the lowest bins may be combined and a new bin provided at the top of the range.

This can support an approach in which the sub-ranges corresponding to the hardware counters are initially skewed towards lower values to allow better discrimination of the input values if they have a distribution of values close to zero, with the bins then combined and the range extended if it is found that the input values have a larger distribution. This approach can improve the quality of information obtained by the histogram because by starting with small bins and extending the range if required, this means that values can be distinguished for various distributions of input values (compared to an approach of starting with large bins, which cannot thereafter be made smaller without discarding the contents, because it cannot be known how the values of the larger bin should be distributed among the smaller bins).

There may be various indexing operations which could be used to identify which hardware counter should be updated in response to a particular input value, where the choice of indexing operation may be related to the boundaries of the sub-ranges. In some examples, the indexing operation may be configured to identify the selected hardware counter based on a bit position of the most significant bit in a binary representation of the target value. Defining the indexing operation in such a way means that the boundaries between sub-ranges correspond to powers of two. This means that as the input value gets larger, the size of the sub-ranges (the bins) also increases.

Choosing the indexing operation in such a way may be beneficial for several reasons. In some examples, the input value may be a positive integer (e.g., representing a count of a number of times a particular event has occurred). In such examples, selecting power of two boundaries between sub-ranges means that for input values having a higher magnitude the bins are larger. It has been observed that in many cases larger values are more widely distributed and hence the selection of larger bins for larger input values is often appropriate. Second, in examples where the lowest two bins are combined and a new bin is defined at the top end of the range, when the sub-ranges have power of two boundaries this leads to the relative size of the bins remaining constant. In comparison, if each sub-range were initially equal in size (e.g., the sub-ranges 0-9, 10-19, 20-29), as bins are combined the relative sizes of bins changes—for instance combining the lower bins in the previous example would give the sub-ranges 0-19, 20-29, 30-39, where the lowest bin is now twice the size of the other two bins. This problem is not present with sub-ranges having power of two boundaries—e.g., a set of three power of two bins may correspond to the sub-ranges 0-1, 2-3, and 4-7, and if the lower two bins are combined and a new bin added with power of two boundaries is provided, the new sub-ranges 0-3, 4-7, 8-15 have the same relative size as the previous sub-ranges). Further, in a data processing system the input value is likely to be represented in a binary format in any case, making such an indexing operation computationally straightforward.

In some examples using power of two boundaries, the updated indexing operation and the previous indexing operation may identify the selected hardware counter based on a different base bit position relative to which the bit position is determined. Precisely how the indexing operation selects a hardware counter may vary by implementation. However, as bins are combined the indexing operation may be updated to calculate the bit position starting from a different bit position due to the fact that the bins corresponding to lower bit positions may have been combined to provide the lowest index bin. In some examples, any input value having a most significant bit below the base bit position may be treated as belonging to the lowest index bin (the bin corresponding to the base bit position). In some examples, a maximum index may be defined with respect to the base bit position (e.g., the base bit position plus the number of hardware counters) and any input value having a most significant bit position greater than the maximum index may be treated as belonging to the highest index bin. Specific examples of such indexing operations will be discussed below, but in general modifying the indexing operation by modifying a base bit position provides a straightforward way for the indexing operation to be updated as hardware counters are combined.

In some examples, the histogram range update trigger may be received by the histogram control circuitry from an external entity. The external entity may for example comprise a consumer of the histogram maintained by the plurality of hardware counters, and may analyse the distribution of values in each bin of the histogram to determine whether to issue the histogram range update trigger. The external entity could also or alternatively comprise a producer of the input values to be counted by the plurality of hardware counters, where the producer of the input values may have some knowledge about the distribution of the input values which it could use to determine when it would be appropriate to update the sub-ranges of the histogram and hence issue the histogram range update trigger. The histogram range update trigger received from the external entity may in some examples indicate how many hardware counters should be combined by the adding circuitry, and the histogram control circuitry may be configured to ensure the relevant hardware counters have been combined before incrementing the hardware counters in response to further input values.

However, in some examples the apparatus may comprise update trigger circuitry configured to issue the histogram range update trigger in response to a determination that a distribution of counts provided by the plurality of hardware counters meets a skewed distribution condition. The skewed distribution condition may vary depending on implementation, and may generally indicate that the distribution of values in the histogram is such that one or more hardware counters (e.g., the hardware counters corresponding to the highest value sub-ranges) have significantly higher values than one or more other hardware counters, and that the distribution of values in the histogram could be made more even if two or more hardware counters were combined and one or more new sub-ranges defined.

In some examples, the update trigger circuitry may also or alternatively be configured to issue the histogram range update trigger in response to identifying more than a threshold number of input values lying outside the contiguous range of target values. In particular, the hardware counter corresponding to a highest (or lowest) sub-range in the contiguous range of target values may be associated with a nominal upper (or lower) limit, where any value above (or, for the lowest sub-range, below) that limit may be considered to be outside of the contiguous range of target values. In different implementations such a value could cause the highest (or lowest) hardware counter to be updated or not, but in either case may be recorded as an instance where the input value lies outside the contiguous range of target values. Recording a threshold number of events where the input value lies outside the contiguous range of target values could indicate that the contiguous range of target values is too limited and should be increased, and hence in some examples this can cause the histogram range update trigger to be issued.

In some examples, the histogram control circuitry may be configured to perform the indexing operation update such that the updated indexing operation identifies the second hardware counter in response to an input value lying within the one or more first sub-ranges or the second sub-range. Hence, following the indexing operation update the second hardware counter corresponds to the combined sub-ranges of the one or more first sub-ranges and the second sub-range.

In some examples, the histogram control circuitry may be responsive to a histogram output event signal to defer the effects of the histogram range update trigger. The histogram output event signal may be received for example from a consumer which intends to read the values of the plurality of hardware counters to obtain the histogram. The histogram range update trigger can cause the meaning of each hardware counter to be changed (as it leads to certain hardware counters being combined and the indexing operation being updated), and therefore if the histogram range update trigger is issued when a consumer is reading out the values of the plurality of hardware counters then this can cause the histogram to be read out incorrectly. By supporting the histogram output event signal, the histogram control circuitry can enable consumers to indicate when they would like to read the histogram and suppress the effects of the histogram range update trigger during those periods to ensure that the histogram can be read correctly. The effects of the histogram update trigger may be deferred for a period (e.g., until a further signal is received indicating that the histogram has been read, or for a predetermined time) to allow the consumer to read the histogram, and may take effect after the end of the period, or in some examples could be deferred indefinitely.

In some examples, the histogram output event signal could cause the histogram control circuitry to enter a readout mode. Following a further signal from the consumer or after a predetermined time, the histogram control circuitry could leave the readout mode by re-enabling the effects of the histogram range update trigger (and, in some examples, resetting the values of the hardware counters). Any histogram range update trigger received whilst in the readout mode could either be implemented after leaving the readout mode or ignored.

In some examples, the histogram control circuitry may be configured to provide an output indicating a degree to which the indexing operation has been updated relative to an initial indexing operation, the output enabling a consumer to determine a sub-range corresponding to each of the plurality of hardware counters. As the sub-range corresponding to each hardware counter changes depending on the number of times the indexing operation has been updated, outputting a value indicating a degree to which the indexing operation has been updated can enable a consumer to interpret the histogram correctly. It will be appreciated that the format of the output value is not particularly limited. For instance, the output could indicate the base bit position in examples where an indexing operation is based on the most significant bit position of the input value, as the base bit position alone may be sufficient to correctly interpret the hardware counter values. In other examples, the output may be issued each time the indexing operation is updated, and the consumer may determine a degree to which the indexing operation has been updated based on counting a number of times the output has been issued. In some examples, the adding circuitry is configured to reset count values of the one or more first hardware counters in response to the count values being added to the second hardware counter. Hence, after the count values of the one or more first hardware counters have been added to the second hardware counter the one or more first hardware counters are reset ready to be used to count a number of times the input value is within the newly defined sub-range.

Some examples may comprise scaling circuitry configured to apply a scaling factor to reduce the magnitude of a source value contributing to the input value. The source value may be the input value itself or a value used to determine the input value prior to the input value being provided to the histogram control circuitry. Reducing the magnitude of the source value can hence reduce the magnitude of the input value. This can be useful for several reasons.

First, this can reduce the storage requirements of the input value prior to the input value being provided to the histogram update circuitry. For example, if the input value is provided from storage circuitry used to track a particular property of a processor (such as a counter used to count latency) then the use of the scaling circuitry can reduce the power and area requirements of the storage circuitry for storing the input value. Second, this can skew the input values towards existing sub-ranges and hence reduce the number of times the histogram range update trigger may be issued, which can reduce power consumption by reducing the number of times the adding circuitry needs to be used to combine hardware counters. For example, in certain cases (e.g., when the un-scaled input value would be an integer multiple of a smaller value) the input values could be scaled down (e.g., by that integer multiple) without any loss of information. Scaling down the input values reduces the likelihood of the histogram distribution being skewed towards the higher end of the contiguous range of input values (and can reduce the likelihood of input values which exceed the contiguous range) and can hence reduce the likelihood of a histogram range update trigger being issued.

As discussed above, the hardware counters may be used to record the distribution of various different values in a processing system and the implementation of such a histogram is not particularly limited. In some examples the hardware counters may be used to provide a histogram in an apparatus comprising cache replacement circuitry. The cache replacement circuitry may be configured to select an entry of a cache for eviction, for example when the cache is required to store a new cache entry but has no capacity. The cache replacement circuitry may be configured to store one or more age indications each associated with a corresponding cache line, the age indications indicating a duration since the last access to the cache line (e.g., measured by a number of access to the set). The age indication may be increased each time an entry other than the corresponding cache line is accessed, and reset if the corresponding cache line is accessed. The age indications may be used to select an entry for eviction (e.g., by evicting the cache line having the highest age indication), but can also be used for monitoring of the data processing apparatus. For example, it may be desired to monitor the distribution of the ages of hit cache lines or evicted cache lines (e.g., as an input for selecting a cache eviction policy), and for this purpose a histogram could be used. Hence, in some examples the cache replacement circuitry may be configured to provide the input value based on the age indication of a given cache line.

In examples where the input value is provided by the cache replacement circuitry, the scaling circuitry may be configured to reduce the magnitude of an age update value used to update the age indication. By reducing the magnitude of the age update value (in the same way for each cache line) the size of the age indications, and hence input values, can be reduced without loss of information.

In examples comprising scaling circuitry, either a block comprising the histogram control circuitry or a block comprising the scaling circuitry could be responsible for issuing the histogram range update trigger. The block comprising the scaling circuitry (and hence generating the events to be counted) may for example have knowledge of the magnitude of the values to be counted by the histogram, and hence could issue the histogram range update trigger to request the histogram updates the way in which it indexes the hardware counters.

In some examples, the histogram control circuitry may be configured to update the scaling factor in response to the histogram range update trigger. The histogram range update trigger may indicate that the input values are skewed towards the upper end of the contiguous range and therefore may be used as an indication that the scaling value can be increased to further decrease the magnitude of the input values.

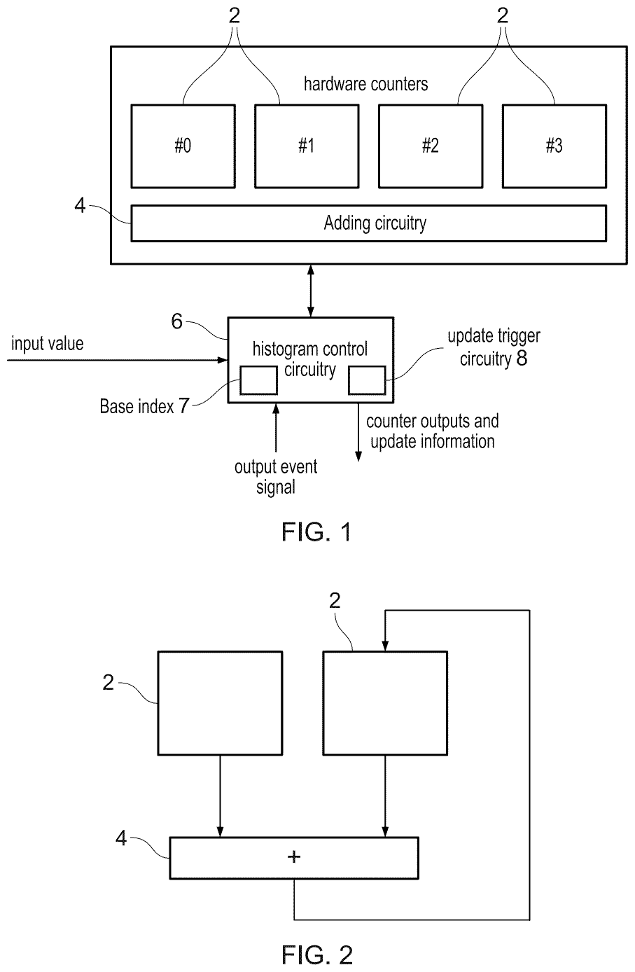

Particular examples will now be described with reference to the accompanying Figures. FIG. 1 schematically illustrates circuitry for providing a histogram in hardware. A fixed number of hardware counters 2 is provided, each hardware counter corresponding to a particular sub-range (bin) of a contiguous range of values. Histogram control circuitry 6 is configured to increment a given hardware counter in response to receiving an input value within the sub-range corresponding to that given hardware counter. Therefore, the hardware counters 2 provide a mechanism for tracking the distribution of the input values within the contiguous range. If an input value is received outside the contiguous range then this could be treated in various ways. For example the histogram control circuitry 6 may update the hardware counter 2 corresponding to a sub-range closest to the out-of-range input value (e.g., if the value is larger than the top end of the contiguous range then the hardware counter having the greatest upper boundary may be incremented), or the out-of-range input value may not cause any of the hardware counters to be updated.

The histogram control circuitry 6 comprises update trigger circuitry 8 configured to issue a histogram range update trigger. In response to the histogram range update trigger, adding circuitry 4 is configured to combine the count values stored by one or more first hardware counters 2 with the count value stored by a second hardware counter 2. After the addition, the second hardware counter 2 therefore stores a count value representing a number of times the input value has been received with a value in any of the sub-ranges of the first or second hardware counters 2. The one or more first hardware counters can then be reset and used to represent a new part of the contiguous range, for example by expanding the limits of the contiguous range. In this way, the hardware counters and addition circuitry can provide a histogram with dynamic bins. This can support use cases where the distribution of the input value is difficult to predict in advance and may change over time, and hence where the boundaries of the sub-ranges are difficult to fix in advance. By adding the contents of previous bins together, samples are retained when redefining the sub-ranges.

The histogram control circuitry 6 is also responsive to the histogram range update trigger to update an indexing operation used to identify which bin should be updated in response to an input value. After bins are combined and a new sub-range is defined, a given input might correspond to a different hardware counter and hence the indexing operation is updated to ensure that the correct hardware counters are incremented following the addition of hardware counters. An example of the indexing operation update will be discussed below. By updating the indexing operation, rather than moving the newly defined bins to maintain the previous indexing operation, power can be saved because the count values stored in the majority of hardware counters may remain unchanged.

FIG. 1 illustrates that the histogram control circuitry 6 stores an indication of a base index 7. As discussed below, the base index 7 may quantify the indexing operation, and hence may be used to identify which hardware counter should be updated for a given input value. The base index 7 may be updated in response to the histogram range update trigger.

FIG. 1 illustrates that the histogram control circuitry 6 is configured to receive an output event signal from a consumer. A consumer may read the histogram by reading the values of the hardware counters 2. However, the consumer may not read all of the hardware counters simultaneously (e.g., the hardware counters 2 may be read in series). If the sub-ranges corresponding to the hardware counters are updated whilst the count values are being read from the hardware counters 2, then this may result in the histogram being read incorrectly. Hence, the histogram control circuitry 6 is responsive to the output event signal to defer the effects of the histogram update trigger for a period (e.g., until a further signal is received indicating that the histogram has been read, or for a predetermined time) to enable the consumer to read the histogram correctly.

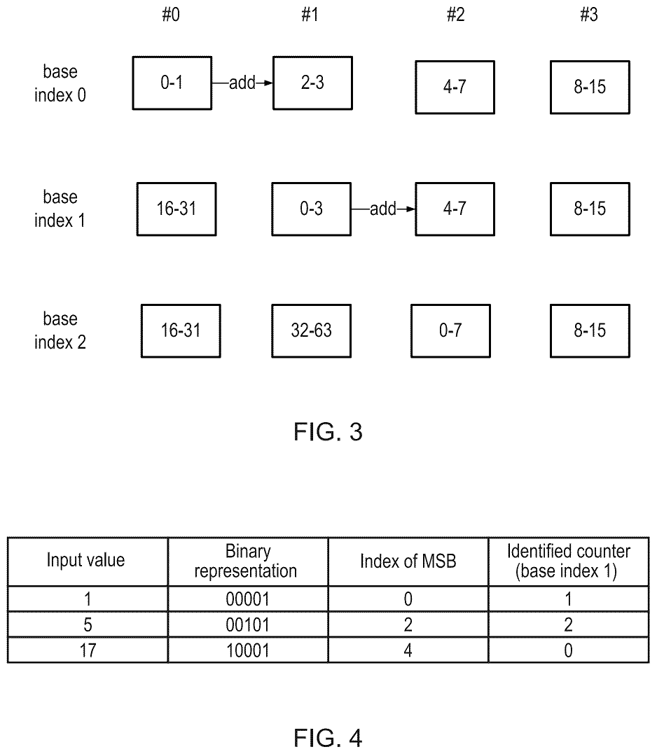

FIG. 1 also illustrates that, as well as the count values from the hardware counters 2, the histogram control circuitry 6 may provide update information to a consumer. The update information may indicate how many times relative to a base setting the sub-ranges of the hardware counters have been updated. In the example discussed with reference to FIG. 3, this could include the base index value 7. As the sub-range corresponding to each hardware counter may vary over the lifetime of the histogram as the indexing operation is updated, providing the update information can enable the consumer to correctly interpret the output count values to determine the distribution of the input value.

FIG. 2 schematically illustrates an example of adding circuitry 4 for combining the count value of a first hardware counter (shown on the left of FIG. 2) with the count value of a second hardware counter (shown on the right of FIG. 2) to provide an updated count value for the second hardware counter. FIG. 2 shows adding circuitry 4 for combining the count values of a pair of hardware counters, for instance a pair of hardware counters corresponding to neighbouring sub-ranges (where neighbouring sub-ranges are those for which the upper bound of one sub-range and the lower bound of the neighbouring sub-range coincide). In some examples, two or more first hardware counters may be combined with a second hardware counter in response to the histogram range update trigger. In these examples, the adding circuitry 4 may be configured to enable count values from three or more neighbouring hardware counters to be combined to perform such additions in one step. In some examples, the adding circuitry used for combining hardware counters may be the same adding circuitry used for incrementing the count value of a given hardware counter.

The hardware counters may in some examples be provided within a random access memory (RAM) block, and hardware control circuitry may be configured to increment a given counter by loading the count value of that counter from the RAM, incrementing the count value, and writing it back to the RAM. Therefore, in some examples each of the hardware counters within the histogram may be accessible by a single instance of addition circuitry. To support the merging of counters during re-indexing, a single adder may obtain both its inputs from the RAM block, perform an addition, and then write the value back to the RAM block. To optimise for re-indexing where multiple bins are merged (e.g., three or more hardware counters are combined), this could be performed as a series of additions where the result of an earlier operation is used as an input in a later operation to avoid needing to write the result of each addition back to the RAM block (and then read it back in again).

As an example, to merge the counters having indices 0, 1, and 2, this could be performed by:
reading RAM block index 0 into input A
reading RAM block index 1 into input B
adding input A and B, storing result as input B
reading RAM block index 2 into input A
adding input A and B, storing result into RAM block index 2.

FIG. 3 schematically illustrates three examples of sub-ranges corresponding to a set of four hardware counters (e.g., as shown in FIG. 1) labelled #0 to #3. The hardware counters shown in FIG. 3 can be used to determine a distribution of an input value. In the example of FIG. 3, the input value is a positive integer.

The top row of FIG. 3 illustrates an example initial set of sub-ranges for the hardware counters when using an indexing operation which selects a hardware counter to increment in response to an input value based on the position of the most significant bit in a binary representation of the input value. Therefore, the boundaries between sub-ranges of the hardware counters are powers of 2. That is, the lowest sub-range (bin), hardware counter #0, is incremented in response to input values lower than 2\hat{ }1=2 (i.e., the sub-range for counter #0 is 0-1). Hardware counter #1 is incremented in response to input values greater than or equal to 2\hat{ }1=2 and lower than 2\hat{ }2=4 (i.e., the sub-range is 2-3), hardware counter #2 is incremented in response to input values greater than or equal to 2\hat{ }2=4 and lower than 2\hat{ }3=8 (the sub-range is 4-7), and hardware counter #3 is incremented in response to input values greater than or equal to 2\hat{ }3=8 and lower than 2\hat{ }4=16 (the sub-range is 8-15). It will be appreciated that the plurality of hardware counters have neighbouring sub-ranges, and overall correspond to the contiguous range 0-15.

The initial setting may correspond to the lowest powers of two so that the distribution of the input value can be properly determined if the input value happens to have small values and be distributed close to zero. If it is later found that the input value is larger then the bins can be combined and new larger sub-ranges defined whilst retaining the count of the previously observed inputs. However, if the initial setting had overly large bins but the input values were small, it would not be possible to reduce the size of the bins whilst retaining previous measurements, because it could not be known which bin those values should be sorted into.

The indexing operation for the initial setting may be implemented in various ways. In general, the bit position of the most significant bit of a binary representation of the input value provides the index for the selected hardware counter. For example, if binary bits are labelled from the least significant bit (i.e., 5, 4, 3, 2, 1, 0), then the value 6 (represented in binary as 0 . . . 00110) has a most significant bit in the bit position with index “2”, and hence the hardware counter #2 is updated in response to the input value 6. The largest index hardware counter may be calculated by adding the number of hardware counters minus 1 (3) to the base index ( #0), and is therefore hardware counter #3. If the input value falls outside of the contiguous range (i.e., is greater than 15), then the calculated index is greater than the largest index and this may be handled either by incrementing hardware counter #3 or not incrementing any counters.

A histogram range update trigger may be issued when it is determined that the sub-ranges corresponding to the hardware counters do not allow the distribution of the input values to be determined sufficiently. For example, if more than a threshold number of input values are observed falling outside the range (larger than 15), or the count values in the hardware counters are skewed towards the upper end, then the distribution of the hardware counters may be determined better if the range was extended towards larger values.

The second row of FIG. 3 illustrates an example set of sub-ranges for the hardware counters following an update from the set of sub-ranges shown in the top row of FIG. 3, e.g., following a histogram range update trigger. In particular, in response to the update the count values of hardware counters #0 and #1 are combined using adding circuitry 4, and the resulting value is stored in hardware counter #1. Hardware counter #1 therefore corresponds to the sub-range of input values 0-3 (0-1 from previous counter #0 and 2-3 from previous counter #1). The hardware counter corresponding to the lowest end of the range is therefore counter #1 following the update, and hence the base index is #1. Hardware counter #0 can therefore be reset and used to correspond to a newly defined sub-range to extend the range. In the example of FIG. 3, hardware counter #0 is used to provide a newly defined sub-range greater than or equal to 2\hat{ }4=16 and lower than 2\hat{ }5=32 (i.e., the newly defined sub-range is 16-31), as for the particular indexing operation used in this example the boundaries of the sub-ranges correspond to powers of two.

FIG. 4 is a table providing several example input values and the identified hardware counters for those input values when the base index is 1, as shown in the second row of FIG. 3. The following is an example indexing operation to select which hardware counter to update:
Determine the base index
Calculate the maximum index by adding number of counters minus 1 to the base index
Identify the most significant bit (MSB) position of the binary input value
Is the position of the MSB below the base index? If so, the selected hardware counter is the counter having the base index
If not, is the position of the MSB above the maximum index? If so, either ignore the input value, or the selected hardware counter is the counter having the maximum index
If not, the selected hardware counter is the counter having the index equal to position of the MSB modulo the number of counters (where the modulo operation is to account for the counter index wrapping around as the lowest bins are combined to provide the new hardware counter).

Using the example of the middle row of FIG. 3, the base index is 1 and, with 4 counters, the maximum index is therefore 4.

As shown in FIG. 4, the input value 1 has an MSB position of 0 which falls below the base index of 1, and hence the selected counter is the base index counter #1.

The input value 5 has an MSB position of 2, which neither falls below the base index or above the maximum index, and hence identifies the hardware counter to update (counter #2 as can be seen in FIG. 3).

Input value 17 has the MSB position of 4, which neither falls below the base index or above the maximum index, and hence identifies the hardware counter to update. In particular 4 modulo 4 is 0 and hence counter #0 is updated.

Hence, the approach used to select which bin to update (and also indicating which bin corresponds to which sub-ranges) can be quantified using the base index value alone, given that the number of hardware counters is fixed.

It will be appreciated that even when defining sub-ranges in the same way as shown in FIG. 3, other approaches could be taken to perform the indexing operation. For example, the most significant bit position could be calculated from a bit position corresponding to the base index.

The bottom row of FIG. 3 illustrates an example set of sub-ranges for the hardware counters following a further update from the set of sub-ranges shown in the middle row of FIG. 3. To go from the middle row to the bottom row of FIG. 3, counters index #1 and #2have been combined to provide new counter #2 corresponding to the sub-range 0-7 (and hence the base index is 2), and the newly available counter #1 has therefore been used to provide the newly defined sub-range 32-63 (greater than or equal to 2\hat{ }5=16 and lower than 2\hat{ }6=64, using the power of 2 indexing approach).

It will be appreciated that the approach of indexing based on power of 2 boundaries is not a necessary feature of the present technique, but has been selected to illustrate a particularly beneficial indexing operation. In particular, this approach is straightforward to perform as it uses the binary representation of input values which will typically already be used in a processor. Binary indexing also results in bins having sizes which increase in size as they get larger, which may be more useful for a histogram as values may typically spread out further as their magnitude increases. Binary indexing also means that as bins are combined, the relative sizes of the bins stays consistent. For example, the size of the sub-ranges in each row if FIG. 3 all have the same ratio of 1:1:2:4 (2:2:4:8 in the top row, 4:4:8:16 in the middle row, and 8:8:16:32 in the bottom row). This can avoid bins becoming distorted as they are combined, which might be a problem if bins are defined in a different way (e.g., if new bins all have the same size, then as bins are combined the lowest bin would become much larger than the other bins).

As illustrated in FIG. 3, the approach of combining bins and using one of the combined hardware counters to provide the new range (e.g., in the middle row counter #0 provides the new rang) means that the sub-ranges corresponding to the other hardware counters remain unchanged. For example, in both the top and middle rows counters #2 and #3 correspond to the same sub-ranges. This hence reduces the power cost of dynamically changing the sub-ranges compared to approaches which maintain ordering of the bins and hence may not involve updating the indexing operation. If maintaining the ordering of the bins (e.g., where #0 is always the lowest bin and #3 always the highest bin), then providing a new bin at the top end of the range and combining the two lowest bins would require the contents of each bin to be moved (e.g., bins #0 and #1 combined in bin #0, previous bin #2 moved to bin #1, etc.) incurring the large power cost.

Although FIG. 3 illustrates an example in which the lowest two bins are combined and a new bin defined to extend the top end of the range, the present techniques could also be used in examples where other bins are combined and the newly defined sub-range does not necessarily need to extend the top end of the range.

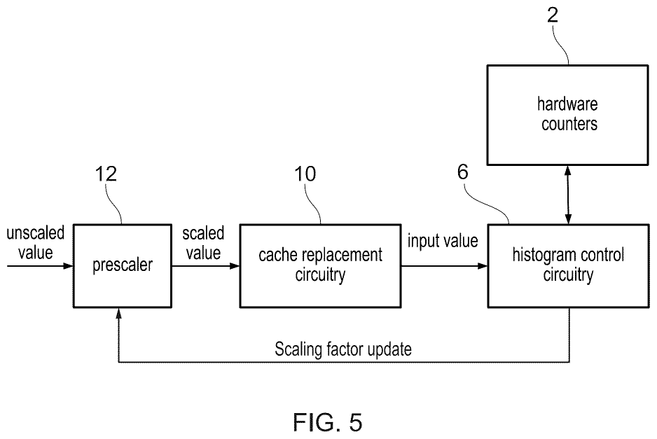

FIG. 5 schematically illustrates an example implementation of a histogram. FIG. 5 illustrates the histogram control circuitry 6 and hardware counters 2 as shown in FIG. 1, and further illustrates circuitry for generating the input values to be received by the histogram control circuitry 6. In particular, FIG. 5 illustrates cache replacement control circuitry 10 for providing the input values to the histogram control circuitry 6. The cache replacement control circuitry 10 is provided for selecting which entry of a cache should be evicted to allow a new entry to be allocated to the cache. The cache replacement control circuitry 10 provides age indications corresponding to cache lines in the cache, each age indication indicating how long the corresponding cache line has been in the cache (e.g., being incremented each time the cache is accessed). When a cache line is evicted from the cache, or when a cache access request hits against a cache line, the age indication of the cache line may be provided as an input value to the histogram control circuitry 6, such that a histogram can record a distribution of cache line ages for evicted and/or hit cache lines. The histogram could be used for various purposes, such as for selecting a cache replacement policy to be applied by the cache replacement circuitry 10.

FIG. 5 illustrates prescaler circuitry 12 for scaling values input to the cache replacement control circuitry 10. For example, the prescaler circuitry may apply a scaling factor to reduce the magnitude of increments to the age indications when the age indication for a particular cache line is increased. By applying a scaling factor, the age indications are reduced and hence there may be a lower storage cost associated with the cache replacement circuitry 10 storing the age indications. In addition, prescaling to reduce the magnitude of the input values may reduce the number of times that a new sub-range needs to be defined for the histogram, by skewing the input values towards the existing sub-ranges. In some examples, the prescaling factor may be increased (to decrease the input values) either as an alternative to, or in addition to, issuing the histogram range update trigger to provide a new higher sub-range. It will be appreciated that although introduced in the context of cache replacement circuitry 10, the prescaler 12 may be used in various implementations of hardware histogram, and in some examples may be inserted directly before the histogram control circuitry 6 to scale an unscaled input value to provide the input value to the histogram control circuitry 6.

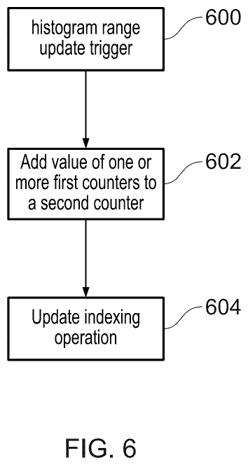

FIG. 6 is a flow diagram illustrating a method of updating sub-ranges corresponding to a plurality of hardware counters 2. At step 600 the update trigger circuitry 8 issues a histogram range update trigger, e.g., in response to determining that input values have been received out of range or that the hardware counters have significantly different count values.

At step 602 adding circuitry adds the count values of one or more first hardware counters to the count value of a second hardware counter, and resets the one or more first hardware counters to be used to represent a new sub-range.

At step 604 the indexing operation is updated such that an input value corresponding to any of the one or more first hardware counters before the update causes the second hardware counter to be updated, and so that an input value in a newly defined sub-range causes one of the one or more first hardware counters to be updated.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

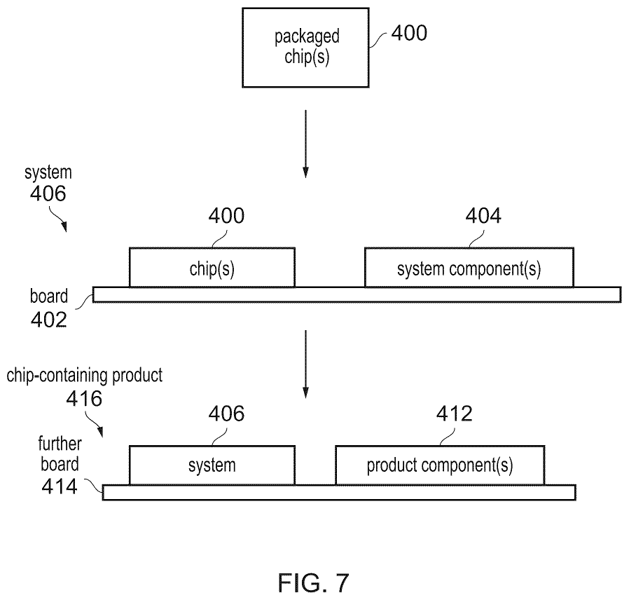

As shown in FIG. 7, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept. Hence, in some examples an apparatus comprises a plurality of hardware counters each corresponding to a separate sub-range of a contiguous range of target values, and histogram control circuitry to perform an indexing operation to identify and increment a selected hardware counter corresponding to a selected sub-range comprising an input value. Responsive to a histogram range update trigger, adding circuitry adds a count value of one or more first hardware counters corresponding to one or more first sub-ranges to a second hardware counter corresponding to a second sub-range neighbouring the one or more first sub-ranges, and the histogram control circuitry updates a previous indexing operation to an updated indexing operation, wherein the updated indexing operation identifies one of the one or more first hardware counters in response to an input value lying within a newly defined sub-range of the contiguous range of target values.

### Some Examples Are Set out in the Following Clauses:

1. An apparatus, comprising:
a plurality of hardware counters each corresponding to a separate sub-range of a contiguous range of target values; and
histogram control circuitry responsive to an input value to perform an indexing operation to identify and increment a selected hardware counter corresponding to a selected sub-range comprising the input value;
wherein, responsive to a histogram range update trigger:
   adding circuitry is configured to add a count value of one or more first hardware counters corresponding to one or more first sub-ranges to a second hardware counter corresponding to a second sub-range neighbouring the one or more first sub-ranges; and
   the histogram control circuitry is configured to perform an indexing operation update to update a previous indexing operation to an updated indexing operation, wherein the updated indexing operation identifies one of the one or more first hardware counters in response to an input value lying within a newly defined sub-range of the contiguous range of target values.

2. The apparatus according to clause 1, wherein the histogram control circuitry is configured to perform the indexing operation update such that the updated indexing operation and the previous indexing operation identify the same hardware counter in response to an input value lying in a range other than the one or more first sub-ranges and one or more newly defined sub-ranges.

3. The apparatus according to clause 2, wherein the plurality of hardware counters other than the one or more first hardware counters and the second hardware counter are configured to remain unchanged in response to the histogram range update trigger.

4. The apparatus according to any preceding clause, wherein the one or more first hardware counters correspond to a lowest value portion of the contiguous range of target values.

5. The apparatus according to any preceding clause, wherein the histogram control circuitry is configured to provide the newly defined sub-range to represent a highest value portion of the contiguous range of target values.

6. The apparatus according to any preceding clause, wherein the indexing operation is configured to identify the selected hardware counter based on a bit position of the most significant bit in a binary representation of the target value.

7. The apparatus according to clause 6, wherein the updated indexing operation and the previous indexing operation identify the selected hardware counter based on a different base bit position relative to which the bit position is determined.

8. The apparatus according to any preceding clause, comprising update trigger circuitry configured to issue the histogram range update trigger in response to a determination that a distribution of counts provided by the plurality of hardware counters meets a skewed distribution condition.

9. The apparatus according to any preceding clause, comprising update trigger circuitry configured to issue the histogram range update trigger in response to identifying more than a threshold number of input values lying outside the contiguous range of target values.

10. The apparatus according to any preceding clause, wherein the histogram control circuitry is configured to perform the indexing operation update such that the updated indexing operation identifies the second hardware counter in response to an input value lying within the one or more first sub-ranges or the second sub-range.

11. The apparatus according to any preceding clause, wherein the histogram control circuitry is responsive to a histogram output event signal to defer the effects of the histogram range update trigger.

12. The apparatus according to any preceding clause, wherein the histogram control circuitry is configured to provide an output indicating a degree to which the indexing operation has been updated relative to an initial indexing operation, the output enabling a consumer to determine a sub-range corresponding to each of the plurality of hardware counters.

13. The apparatus according to any preceding clause, wherein the adding circuitry is configured to reset count values of the one or more first hardware counters in response to the count values being added to the second hardware counter.

14. The apparatus according to any preceding clause, comprising scaling circuitry configured to apply a scaling factor to reduce the magnitude of a source value contributing to the input value.

15. The apparatus according to clause 14, comprising cache replacement circuitry configured to store one or more age indications each associated with a corresponding cache line; wherein
the cache replacement circuitry is configured to provide the input value based on the age indication of a given cache line; and
the scaling circuitry is configured to reduce the magnitude of an age update value used to update the age indication.

16. The apparatus according to any of clauses 14 and 15, wherein the histogram control circuitry is configured to update the scaling factor in response to the histogram range update trigger.

17. a system comprising:
the apparatus of any preceding clause, implemented in at least one packaged chip; at least one system component; and
a board,
wherein the at least one packaged chip and the at least one system component are assembled on the board.

18. A chip-containing product comprising the system of clause 17, wherein the system is assembled on a further board with at least one other product component.

19. A method, comprising:
providing a plurality of hardware counters each corresponding to a separate sub-range of a contiguous range of target values;
responsive to an input value, performing an indexing operation to identify and increment a selected hardware counter corresponding to a selected sub-range comprising the input value; and
responsive to a histogram range update trigger:
   adding a count value of one or more first hardware counters corresponding to one or more first sub-ranges to a second hardware counter corresponding to a second sub-range neighbouring the one or more first sub-ranges; and
   performing an indexing operation update to update a previous indexing operation to an updated indexing operation, wherein the updated indexing operation identifies one of the one or more first hardware counters in response to an input value lying within a newly defined sub-range of the contiguous range of target values.

20. Computer-readable code for fabrication of an apparatus, comprising:
a plurality of hardware counters each corresponding to a separate sub-range of a contiguous range of target values; and
histogram control circuitry responsive to an input value to perform an indexing operation to identify and increment a selected hardware counter corresponding to a selected sub-range comprising the input value;
wherein responsive to a histogram range update trigger:
   adding circuitry is configured to add a count value of one or more first hardware counters corresponding to one or more first sub-ranges to a second hardware counter corresponding to a second sub-range neighbouring the one or more first sub-ranges; and
   the histogram control circuitry is configured to perform an indexing operation update to update a previous indexing operation to an updated indexing operation, wherein the updated indexing operation identifies one of the one or more first hardware counters in response to an input value lying within a newly defined sub-range of the contiguous range of target values.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
a plurality of hardware counters each corresponding to a separate sub-range of a contiguous range of target values; and
histogram control circuitry responsive to an input value to perform an indexing operation to identify and increment a selected hardware counter corresponding to a selected sub-range comprising the input value;
wherein, responsive to a histogram range update trigger:
adding circuitry is configured to add a count value of one or more first hardware counters corresponding to one or more first sub-ranges to a second hardware counter corresponding to a second sub-range neighbouring the one or more first sub-ranges; and
the histogram control circuitry is configured to perform an indexing operation update to update a previous indexing operation to an updated indexing operation, wherein the updated indexing operation identifies one of the one or more first hardware counters in response to an input value lying within a newly defined sub-range of the contiguous range of target values.

2. The apparatus according to claim 1, wherein the histogram control circuitry is configured to perform the indexing operation update such that the updated indexing operation and the previous indexing operation identify the same hardware counter in response to an input value lying in a range other than the one or more first sub-ranges and one or more newly defined sub-ranges.

3. The apparatus according to claim 2, wherein the plurality of hardware counters other than the one or more first hardware counters and the second hardware counter are configured to remain unchanged in response to the histogram range update trigger.

4. The apparatus according to claim 1, wherein the one or more first hardware counters correspond to a lowest value portion of the contiguous range of target values.

5. The apparatus according to claim 1, wherein the histogram control circuitry is configured to provide the newly defined sub-range to represent a highest value portion of the contiguous range of target values.

6. The apparatus according to claim 1, wherein the indexing operation is configured to identify the selected hardware counter based on a bit position of the most significant bit in a binary representation of the target value.

7. The apparatus according to claim 6, wherein the updated indexing operation and the previous indexing operation identify the selected hardware counter based on a different base bit position relative to which the bit position is determined.

8. The apparatus according to claim 1, comprising update trigger circuitry configured to issue the histogram range update trigger in response to a determination that a distribution of counts provided by the plurality of hardware counters meets a skewed distribution condition.

9. The apparatus according to claim 1, comprising update trigger circuitry configured to issue the histogram range update trigger in response to identifying more than a threshold number of input values lying outside the contiguous range of target values.

10. The apparatus according to claim 1, wherein the histogram control circuitry is configured to perform the indexing operation update such that the updated indexing operation identifies the second hardware counter in response to an input value lying within the one or more first sub-ranges or the second sub-range.

11. The apparatus according to claim 1, wherein the histogram control circuitry is responsive to a histogram output event signal to defer the effects of the histogram range update trigger.

12. The apparatus according to claim 1, wherein the histogram control circuitry is configured to provide an output indicating a degree to which the indexing operation has been updated relative to an initial indexing operation, the output enabling a consumer to determine a sub-range corresponding to each of the plurality of hardware counters.

13. The apparatus according to claim 1, wherein the adding circuitry is configured to reset count values of the one or more first hardware counters in response to the count values being added to the second hardware counter.

14. The apparatus according to claim 1, comprising scaling circuitry configured to apply a scaling factor to reduce the magnitude of a source value contributing to the input value.

15. The apparatus according to claim 14, comprising cache replacement circuitry configured to store one or more age indications each associated with a corresponding cache line; wherein
the cache replacement circuitry is configured to provide the input value based on the age indication of a given cache line; and
the scaling circuitry is configured to reduce the magnitude of an age update value used to update the age indication.

16. The apparatus according to claim 14, wherein the histogram control circuitry is configured to update the scaling factor in response to the histogram range update trigger.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method, comprising:
providing a plurality of hardware counters each corresponding to a separate sub-range of a contiguous range of target values;
responsive to an input value, performing an indexing operation to identify and increment a selected hardware counter corresponding to a selected sub-range comprising the input value; and
responsive to a histogram range update trigger:
adding a count value of one or more first hardware counters corresponding to one or more first sub-ranges to a second hardware counter corresponding to a second sub-range neighbouring the one or more first sub-ranges; and
performing an indexing operation update to update a previous indexing operation to an updated indexing operation, wherein the updated indexing operation identifies one of the one or more first hardware counters in response to an input value lying within a newly defined sub-range of the contiguous range of target values.

20. A non-transitory computer-readable medium storing computer-readable code for fabrication of an apparatus, comprising:
a plurality of hardware counters each corresponding to a separate sub-range of a contiguous range of target values; and
histogram control circuitry responsive to an input value to perform an indexing operation to identify and increment a selected hardware counter corresponding to a selected sub-range comprising the input value;
wherein responsive to a histogram range update trigger:
adding circuitry is configured to add a count value of one or more first hardware counters corresponding to one or more first sub-ranges to a second hardware counter corresponding to a second sub-range neighbouring the one or more first sub-ranges; and
the histogram control circuitry is configured to perform an indexing operation update to update a previous indexing operation to an updated indexing operation, wherein the updated indexing operation identifies one of the one or more first hardware counters in response to an input value lying within a newly defined sub-range of the contiguous range of target values.
